(19) United States
(12) Patent Application Publication
(10) Pub. No.: US 2026/0010163 A1
(43) Pub. Date: Jan. 8, 2026

(54) TRAJECTORY TRACKING CONTROL METHOD FOR UNMANNED HELICOPTERS BASED ON FILTER OBSERVER

(71) Applicant: Nanjing University of Aeronautics and Astronautics, Nanjing (CN)

(72) Inventors: Zhenhua ZHAO, Nanjing (CN); Nan SU, Nanjing (CN); Bin JIANG, Nanjing (CN)

(73) Assignee: Nanjing University of Aeronautics and Astronautics, Nanjing (CN)

(21) Appl. No.: 19/037,337

(22) Filed: Jan. 27, 2025

(30) Foreign Application Priority Data
Jul. 4, 2024 (CN) 202410892395.4

(51) Int. Cl. G05D 1/495; G05D 1/46; G05D 109/25

(52) U.S. Cl. CPC G05D 1/495; G05D 1/46; G05D 2109/25

(57) ABSTRACT

A trajectory tracking control method for the unmanned helicopter based on the filter observer is provided. This method establishes a position system model of the disturbed unmanned helicopter including a lumped disturbance term and a measurement noise term, then, the state vector is constructed based on the actual position and actual speed of the unmanned helicopter, the position system model of the disturbed unmanned helicopter is transformed into the system state equation based on the state vector, according to the system state equation, the filter observer is designed based on the continuous-time Kalman filter, and the composite PID controller is designed for the position system model of the disturbed unmanned helicopter, the trajectory tracking control of the disturbed unmanned helicopter using the composite PID controller combined with the filter observer can perform dynamic real-time feedforward compensation for the lumped disturbance and achieve effective suppression of the measurement noise.

### CROSS-REFERENCE TO THE RELATED APPLICATIONS

This application is based upon and claims priority to Chinese Patent Application No. 202410892395.4, filed on Jul. 4, 2024, the entire contents of which are incorporated herein by reference.

### TECHNICAL FIELD

This application involves flight control technology, especially a trajectory tracking control method for an unmanned helicopter based on a filter observer.

### BACKGROUND

With the continuous progress of modern control theory, unmanned helicopters have been widely used in many fields such as military, civilian, and scientific research. Unmanned helicopters show extremely high flexibility and adaptability in performing diverse tasks in complex environments due to their ability to achieve fixed-point hovering, low-altitude flight, and vertical take-off and landing. However, the unmanned helicopter is a highly nonlinear and strongly coupled system, during the flight process, it is susceptible to multi-source noise and disturbance such as engine vibration, transmission mechanism vibration, aerodynamic parameter perturbation, unmodeled dynamics, and external disturbance. In addition, when the sensor is used to obtain the position information of the unmanned helicopter, it will inevitably be affected by the sensor measurement noise. In this context, how to effectively filter out the influence of high-frequency noise in measurement information and suppress the influence of multi-source disturbance, to achieve high-precision trajectory tracking, has become a challenging problem in the trajectory tracking process of unmanned helicopters.

Aiming at the anti-disturbance control problem of unmanned helicopters, domestic and foreign scholars have given a variety of anti-disturbance control strategies, including a robust control strategy that relies on the robustness of the system to eliminate disturbance passively and an active anti-disturbance control strategy that relies on the extended state observer for real-time observation and feedforward compensation of disturbance. However, the anti-disturbance performance of the existing robust control strategy is obtained at the expense of the nominal performance of the system, while the active anti-disturbance control strategy based on extended state observer will significantly amplify the adverse effects of measurement noise in the presence of measurement noise in the system.

### SUMMARY

Aiming at the above problems and technical requirements, this application proposes a trajectory tracking control method for an unmanned helicopter based on a filter observer, the technical scheme of this application is as follows:

A trajectory tracking control method for an unmanned helicopter based on a filter observer is proposed, the trajectory tracking control method for the unmanned helicopter includes:
establishing a position system model of a disturbed unmanned helicopter, the position system model of the disturbed unmanned helicopter includes a position dynamic equation of the unmanned helicopter under an action of a control variable and a position measurement equation of a position measurement sensor in the unmanned helicopter, the position dynamic equation contains a lumped disturbance term used to characterize an external disturbance of the unmanned helicopter, the position measurement equation contains a measurement noise term used to characterize a measurement error disturbance of the position measurement sensor;
constructing a state vector by an actual position and an actual speed of the unmanned helicopter, transforming the position system model of the disturbed unmanned helicopter into a system state equation based on the state vector, and designing the filter observer based on a continuous-time Kalman filter according to the system state equation;
designing a composite proportion integration differentiation (PID) controller for the position system model of the disturbed unmanned helicopter;
when a trajectory tracking control of the unmanned helicopter is performed, inputting the control variable of the unmanned helicopter and a position measurement value of the position measurement sensor into the filter observer to obtain an actual position estimated value and an estimated value of the lumped disturbance term, inputting a position error between the actual position estimated value and a three-dimensional reference trajectory and the estimated value of the lumped disturbance term into the composite PID controller, and controlling the unmanned helicopter according to a command value of the control variable output by the composite PID controller.

The beneficial technical effects of this application are as follows:

This application discloses a trajectory tracking control method for unmanned helicopters based on a filter observer, this method feeds back the lumped disturbance estimation information to the design of composite PID controller, by performing a dynamic real-time feedforward compensation for the lumped disturbance, the anti-disturbance performance and robustness of the system are significantly improved, in addition, while obtaining the dynamic position tracking error and the lumped disturbance estimation information, the effective suppression of the measurement noise is realized, this method can not only significantly improve the tracking accuracy in the unmanned helicopter control system, but also the proposed control method can be applied to the high-precision control of other aircraft, which has a very broad application prospect.

### BRIEF DESCRIPTION OF THE DRAWINGS

FIG. 1 is a control block diagram of the trajectory tracking control method for the unmanned helicopter in the embodiment of this invention.

FIG. 2 is a comparison diagram of the tracking trajectories of the two control methods in the simulation example.

FIGS. 3A-3C show a comparison diagram of the three-channel tracking error response curves of the two control methods in the simulation example.

FIGS. 4A-4C show a comparison diagram of the three-channel MAE response curves of the two control methods in the simulation example.

FIGS. 5A-5C show a comparison diagram of the response curves of the virtual control variable of the two control methods in the simulation example.

FIGS. 6A-6C show a comparison diagram of the response curves of the virtual control variable change rate of the two control methods in the simulation example.

FIGS. 7A-7C show a comparison diagram of the estimation errors of the three-channel lumped disturbance term of the two control methods in the simulation example.

### DETAILED DESCRIPTION OF THE EMBODIMENTS

The following is a further explanation of the specific embodiment of this application in combination with the accompanying figures.

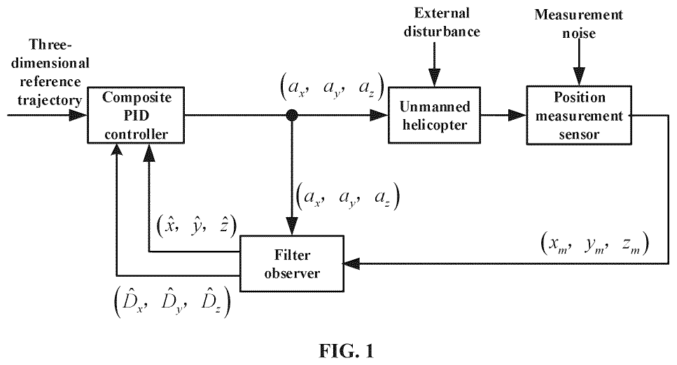

This application discloses a trajectory tracking control method for the unmanned helicopter based on the filter observer, combined with the control block diagram shown in FIG. 1, the trajectory tracking control method for the unmanned helicopter includes the following contents:

Step 1, the position system model of the disturbed unmanned helicopter is established, the position system model of the disturbed unmanned helicopter includes the position dynamic equation of the unmanned helicopter under the action of the control variable and the position measurement equation of the position measurement sensor in the unmanned helicopter.

The position dynamic equation indicates the position change of the unmanned helicopter, because the unmanned helicopter will be affected by external disturbance, the position dynamic equation contains a lumped disturbance term used to characterize the external disturbance of the unmanned helicopter. The position dynamic equation of unmanned helicopter is established as follows:

$$\{ \begin{matrix}\ddot{x} = - \frac{{k}_{d}}{m} \dot{x} + \frac{{T}_{m}}{m} ( cos ϕ sin θ cos ψ + sin ϕ sin ψ ) + {D}_{x} \\ \ddot{y} = - \frac{{k}_{d}}{m} \dot{y} + \frac{{T}_{m}}{m} ( cos ϕ sin θ sin ψ - sin ϕ cos ψ ) + {D}_{y} \\ \ddot{z} = - \frac{{k}_{d}}{m} \dot{z} + \frac{{T}_{m}}{m} cos ϕ cos θ + g + {D}_{z}\end{matrix} \qquad ( 1 )$$

where (x, y, z) is the actual position of the unmanned helicopter in the three axis directions of the inertial coordinate system, (Dₓ, D_{y}, D_{z}) is the lumped disturbance term in the three axis directions of the inertial coordinate system.

\dot{x} denotes the first derivative of the actual position in the x-axis direction of the inertial coordinate system, that is, the actual speed in the x-axis direction of the inertial coordinate system. \ddot{x} denotes the second derivative of the actual position in the x-axis direction of the inertial coordinate system. The first derivative and second derivative of other parameters are expressed in the same way, and they are not repeated one by one in the subsequent content.

m is the mass of the unmanned helicopter, g is the acceleration constant of gravity, k_{d} is the velocity damping coefficient, these parameters are known parameters. In one embodiment, m=6 kg, g =9.8m/s², k_{d}=0.09.

The control variables of the unmanned helicopter include the main rotor lift force Tₘ, the roll angle ϕ, the pitching angle θ and the heading angle ψ.

In order to simplify the description and design, the virtual control variables of aₓ, a_{y}, a_{z} are introduced:

$$\{ \begin{matrix}{a}_{x} = \frac{{T}_{m}}{m} ( cos ϕ sin θ cos ψ + sin ϕ sin ψ ) \\ {a}_{y} = \frac{{T}_{m}}{m} ( cos ϕ sin θ sin ψ - sin ϕ cos ψ ) \\ {a}_{z} = \frac{{T}_{m}}{m} cos ϕ cos θ + g\end{matrix} \qquad ( 2 )$$

The position dynamic equation based on the control variable shown in Formula (1) can be rewritten as the position dynamic equation based on the virtual control variable as follows:

$$\{ \begin{matrix}\ddot{x} = {a}_{x} - \frac{{k}_{d}}{m} \dot{x} + {D}_{x} \\ \ddot{y} = {a}_{y} - \frac{{k}_{d}}{m} \dot{y} + {D}_{y} \\ \ddot{z} = {a}_{z} - \frac{{k}_{d}}{m} \dot{z} + {D}_{z}\end{matrix} \qquad ( 3 )$$

The position measurement equation indicates the relationship between the position measurement value obtained by the position measurement sensor in the unmanned helicopter and the actual position, since the measurement sensor will be disturbed by the measurement error, the position measurement equation contains the measurement noise term used to characterize the measurement error disturbance of the position measurement sensor. The position measurement equation of the position measurement sensor in the unmanned helicopter is established as follows:

$$\{ \begin{matrix}{x}_{m} = x + {v}_{m} \\ {y}_{m} = y + {v}_{my} \\ {z}_{m} = z + {v}_{mz}\end{matrix} \qquad ( 4 )$$

where (xₘ, yₘ, zₘ) is the position measurement value in the three axis directions of the inertial coordinate system obtained by the position measurement sensor in the unmanned helicopter, (vₘₓ, v_{my}, v_{mz}) is the measurement noise term of the position measurement sensor in the unmanned helicopter in the three axis directions of the inertial coordinate system. The measurement noise term is usually Gaussian white noise satisfying vₘₓ˜(0, Rₓ), v_{my}˜(0, R_{y}) and v_{mz}˜(0, R_{z}), where Rₓ is the covariance of the measurement noise term vₘₓ, R_{y} is the covariance of the measurement noise term v_{my}, R_{z} is the covariance of the measurement noise term v_{mz}. In one embodiment, Rₓ=Rₓ=Rₓ=0.04.

Step 2, the state vector is constructed based on the actual position (x, y, z) and actual speed (\dot{x}, \dot{y}, ż) of the unmanned helicopter, the position system model of the disturbed unmanned helicopter is transformed into a system state equation based on the state vector, and the filter observer is designed based on the continuous-time Kalman filter according to the system state equation.

When designing the filter observer in this step, three-channel filter observers are designed for the three axis directions of the inertial coordinate system, including:

### (1) For the X-Axis Direction of the Inertial Coordinate System

Firstly, the state vector X=[x vₓ]^{T} and the derivative \dot{X} =[\dot{x} \dot{v}ₓ]^{T} of the state vector of the unmanned helicopter in the x-axis direction of the inertial coordinate system are constructed. vₓ=\dot{x} denotes the actual speed of the unmanned helicopter in the x-axis direction of the inertial coordinate system, and \dot{v}ₓ=\ddot{x} denotes the actual acceleration of the unmanned helicopter in the x-axis direction of the inertial coordinate system.

Then, according to (3) and (4) of the position system model of the disturbed unmanned helicopter, the system state equation in the x-axis direction of the inertial coordinate system is as follows:

$$\{ \begin{matrix}\dot{X} = {A}_{x} X + {B}_{x} {a}_{x} + {B}_{dx} {D}_{x} \\ {x}_{m} = {H}_{x} X + {v}_{mx}\end{matrix} \qquad ( 5 )$$

$$where {A}_{x} = [ \begin{matrix}0 & 1 \\ 0 & - \frac{{k}_{d}}{m}\end{matrix} ] , {B}_{x} = [ \begin{matrix}0 \\ 1\end{matrix} ] , {B}_{dx} = [ \begin{matrix}0 \\ 1\end{matrix} ] , {H}_{x} = [ \begin{matrix}1 \\ 0\end{matrix} ] .$$

Then, based on the system state equation (5), a filter observer in the x-axis direction of the inertial coordinate system is designed to observe the actual position estimated value and the estimated value of the lumped disturbance term in the x-axis direction. The filter observer in the x-axis direction of the inertial coordinate system is designed as:

$$\{ \begin{matrix}{K}_{x} = {P}_{x} {H}_{x}^{T} {R}_{x}^{- 1} \\ \dot{\tilde{X}} = {A}_{x} \tilde{X} + {B}_{x} {a}_{x} + {B}_{dx} {\hat{D}}_{x} + {K}_{x} ( {x}_{m} - {H}_{x} \tilde{X} ) \\ {\dot{P}}_{x} = - {P}_{x} {H}_{x}^{T} {R}_{x}^{- 1} {H}_{x} {P}_{x} + {A}_{x} {P}_{x} + {P}_{x} {A}_{x}^{T} + {Q}_{x}\end{matrix} \qquad ( 6 )$$

$$\{ \begin{matrix}{e}_{Ox} = {z}_{x 1} - \tilde{x} \\ {\dot{z}}_{x 1} = {z}_{x 2} - {β}_{01}^{x} {e}_{Ox} \\ {\dot{z}}_{x 2} = {z}_{x 3} - {β}_{02}^{x} {e}_{Ox} - \frac{{k}_{d}}{m} {z}_{x 2} + {a}_{x} \\ {\dot{z}}_{x 3} = - {β}_{03}^{x} {e}_{Ox} \\ \hat{x} = {z}_{x 1} \\ \hat{\dot{x}} = {z}_{x 2} \\ {\hat{D}}_{x} = {z}_{x 3}\end{matrix} \qquad ( 7 )$$

where Kₓ∈R^{2×1} is the Kalman gain, Pₓ∈R^{2×2} is the covariance matrix of the state vector estimation X. \tilde{X}=[\tilde{x} \tilde{v}ₓ]^{T} is the estimated value of the system state in the x-axis direction obtained by the Kalman filter, \tilde{\dot{X}}=[\tilde{\dot{x}} \tilde{\dot{v}}ₓ]^{T} is the first derivative of the estimated value \tilde{X}, \tilde{x} denotes the position estimated value in the x-axis direction obtained by the Kalman filter, and \tilde{v}ₓ denotes the velocity estimated value in the x-axis direction obtained by the Kalman filter, î denotes the estimated value of the actual position of the unmanned helicopter in the x-axis direction of the inertial coordinate system, and \hat{v}ₓ=\dot{\hat{x}} denotes the actual velocity estimated value of the unmanned helicopter in the x-axis direction of the inertial coordinate system, that is, the estimated value of the first derivative of the actual position. \hat{D}ₓ denotes the estimated value of the lumped disturbance term in the x-axis direction of the inertial coordinate system. Qₓ∈R^{2×2} denotes the covariance matrix of the estimated lumped disturbance term \hat{D}ₓ, in an embodiment,

$${Q}_{x} = [ \begin{matrix}0 & 0 \\ 0 & 5000\end{matrix} ] .$$

The estimated values of other parameters are also expressed in the same way, and they are not repeated one by one in the subsequent content.

zₓ₁, zₓ₂, zₓ₃ are the intermediate variables of the filter observer.

$${β}_{01}^{x} , {β}_{02}^{x} , {β}_{03}^{x}$$

are positive constants and their values satisfy

$${P}^{x} ( s ) = {s}^{3} + {β}_{01}^{x} {s}^{2} + {β}_{02}^{x} s + {β}_{03}^{x}$$

and belong to Hurwitz, s is the complex frequency domain parameter. In one embodiment,

$${β}_{01}^{x} = 18 , {β}_{02}^{x} = 108 , {β}_{03}^{x} = 216.$$

### (2) For the Y-Axis Direction of the Inertial Coordinate System

The state vector Y=[y v_{y}]^{T} and the derivative \dot{Y}=[\dot{y} \dot{v}_{y}]^{T} of the state vector of the unmanned helicopter in the y-axis direction of the inertial coordinate system are constructed. v_{y}=\dot{y} denotes the actual speed of the unmanned helicopter in the y-axis direction of the inertial coordinate system, and \dot{v}_{y}=ÿ denotes the actual acceleration of the unmanned helicopter in the y-axis direction of the inertial coordinate system.

Then, according to (3) and (4) of the position system model of the disturbed unmanned helicopter, the system state equation in the y-axis direction of the inertial coordinate system is as follows:

$$\{ \begin{matrix}\dot{Y} = {A}_{y} Y + {B}_{y} {a}_{y} + {B}_{dy} {D}_{y} \\ {y}_{m} = {H}_{y} Y + {v}_{my}\end{matrix} \qquad ( 8 )$$

$$where {A}_{y} = [ \begin{matrix}0 & 1 \\ 0 & - \frac{{k}_{d}}{m}\end{matrix} ] , {B}_{y} = [ \begin{matrix}0 \\ 1\end{matrix} ] , {B}_{dy} = [ \begin{matrix}0 \\ 1\end{matrix} ] , {H}_{y} = [ \begin{matrix}1 \\ 0\end{matrix} ] .$$

Based on the system state equation (8), a filter observer in the y-axis direction of the inertial coordinate system is designed to observe the actual position estimated value and the estimated value of the lumped disturbance term in the y-axis direction. The filter observer in the y-axis direction of the inertial coordinate system is designed as:

$$\{ \begin{matrix}{K}_{y} = {P}_{y} {H}_{y}^{T} {R}_{y}^{- 1} \\ \dot{\tilde{Y}} = {A}_{y} \tilde{Y} + {B}_{y} {a}_{y} + {B}_{dy} {\hat{D}}_{y} + {K}_{y} ( {y}_{m} - {H}_{y} \tilde{Y} ) \\ {\dot{P}}_{y} = - {P}_{y} {H}_{y}^{T} {R}_{y}^{- 1} {H}_{y} {P}_{y} + {A}_{y} {P}_{y} + {P}_{y} {A}_{y}^{T} + {Q}_{y}\end{matrix} \qquad ( 9 )$$

$$\{ \begin{matrix}{e}_{Oy} = {z}_{y 1} - \tilde{y} \\ {\dot{z}}_{y 1} = {z}_{y 2} - {β}_{01}^{y} {e}_{Oy} \\ {\dot{z}}_{y 2} = {z}_{y 3} - {β}_{02}^{y} {e}_{Oy} - \frac{{k}_{d}}{m} {z}_{y 2} + {a}_{y} \\ {\dot{z}}_{y 3} = - {β}_{03}^{y} {e}_{Oy} \\ \hat{y} = {z}_{y 1} \\ \hat{\dot{y}} = {z}_{y 2} \\ {\hat{D}}_{y} = {z}_{y 3}\end{matrix} \qquad ( 10 )$$

where K_{y}∈R^{2×1} is the Kalman gain, P_{y}∈R^{2×2} is the covariance matrix of the state vector estimation Y. \tilde{Y}=[\tilde{y} \tilde{v}_{y}]^{T} is the estimated value of the system state in the y-axis direction obtained by the Kalman filter, \tilde{\dot{Y}}=[\tilde{\dot{y}} \tilde{\dot{v}}_{y}]^{T} is the first derivative of the estimated value \tilde{Y}, \tilde{y} denotes the actual position estimated value in the y-axis direction obtained by the Kalman filter, and \tilde{v}_{y} denotes the velocity estimated value in the y-axis direction obtained by the Kalman filter, ŷ denotes the estimated value of the actual position of the unmanned helicopter in the y-axis direction of the inertial coordinate system, and \hat{v}_{y}=\dot{ŷ} denotes the actual velocity estimated value of the unmanned helicopter in the y-axis direction of the inertial coordinate system. \hat{D}_{y} denotes the estimated value of the lumped disturbance term in the y-axis direction of the inertial coordinate system. Q_{y}∈R^{2×2} denotes the covariance matrix of the estimated lumped disturbance term \hat{D}_{y}, in an embodiment,

$${Q}_{y} = [ \begin{matrix}0 & 0 \\ 0 & 5000\end{matrix} ] .$$

z_{y1}, z_{y2}, z_{y3} are the intermediate variables of the filter observer.

$${β}_{01}^{y} , {β}_{02}^{y} , {β}_{03}^{y}$$

are positive constants and their values satisfy

$${P}^{y} ( s ) = {s}^{3} + {β}_{01}^{y} {s}^{2} + {β}_{02}^{y} s + {β}_{03}^{y}$$

and belong to Hurwitz. In one embodiment,

$${β}_{01}^{y} = 18 , {β}_{02}^{y} = 108 , {β}_{03}^{y} = 216.$$

### (3) For the Z-Axis Direction of the Inertial Coordinate System

The state vector Z=[z v_{z}]^{T} and the derivative Ż=[ż \dot{v}_{z}]^{T} of the state vector of the unmanned helicopter in the z-axis direction of the inertial coordinate system are constructed. v_{z}=ż denotes the actual speed of the unmanned helicopter in the z-axis direction of the inertial coordinate system, and \dot{v}_{z}=\ddot{z} denotes the actual acceleration of the unmanned helicopter in the z-axis direction of the inertial coordinate system.

Then, according to (3) and (4) of the position system model of the disturbed unmanned helicopter, the system state equation in the z-axis direction of the inertial coordinate system is as follows:

$$\{ \begin{matrix}\dot{Z} = {A}_{z} Z + {B}_{z} {a}_{z} + {B}_{dz} {D}_{z} \\ {z}_{m} = {H}_{z} Z + {v}_{mz}\end{matrix} \qquad ( 11 )$$

$$where {A}_{z} = [ \begin{matrix}0 & 1 \\ 0 & - \frac{{k}_{d}}{m}\end{matrix} ] , {B}_{z} = [ \begin{matrix}0 \\ 1\end{matrix} ] , {B}_{dz} = [ \begin{matrix}0 \\ 1\end{matrix} ] , {H}_{z} = [ \begin{matrix}1 \\ 0\end{matrix} ] .$$

Based on the system state equation (11), a filter observer in the z-axis direction of the inertial coordinate system is designed to observe the actual position estimated value and the estimated value of the lumped disturbance term in the z-axis direction. The filter observer in the z-axis direction of the inertial coordinate system is designed as:

$$\{ \begin{matrix}{K}_{z} = {P}_{z} {H}_{z}^{T} {R}_{z}^{- 1} \\ \dot{\tilde{Z}} = {A}_{z} \tilde{Z} + {B}_{z} {a}_{z} + {B}_{dz} {\hat{D}}_{z} + {K}_{z} ( {z}_{m} - {H}_{z} \tilde{Z} ) \\ {\dot{P}}_{z} = - {P}_{z} {H}_{z}^{T} {R}_{z}^{- 1} {H}_{z} {P}_{z} + {A}_{z} {P}_{z} + {P}_{z} {A}_{z}^{T} + {Q}_{z}\end{matrix} \qquad ( 12 )$$

$$\{ \begin{matrix}{e}_{Oz} = {z}_{z 1} - \tilde{z} \\ {\dot{z}}_{z 1} = {z}_{z 2} - {β}_{01}^{z} {e}_{Oz} \\ {\dot{z}}_{z 2} = {z}_{z 3} - {β}_{02}^{z} {e}_{Oz} - \frac{{k}_{d}}{m} {z}_{z2} + {a}_{z} \\ {\dot{z}}_{z3} = - {β}_{03}^{z} {e}_{Oz} \\ \hat{z} = {z}_{z 1} \\ \hat{\dot{z}} = {z}_{z 2} \\ {\hat{D}}_{z} = {z}_{z 3}\end{matrix} \qquad ( 13 )$$

where K_{z}∈R^{2×1} is the Kalman gain, P_{z}∈R^{2×2} is the covariance matrix of the state vector estimation Z. \tilde{Z}=[\tilde{z} \tilde{v}_{z}]^{T} is the estimated value of the system state in the z-axis direction obtained by the Kalman filter, \tilde{ż}=[\tilde{ż} \tilde{\dot{v}}]^{T} is the first derivative of the estimated value \tilde{Z}, \tilde{z} denotes the position estimated value in the z-axis direction obtained by the Kalman filter, and \tilde{v}_{z} denotes the velocity estimated value in the z-axis direction obtained by the Kalman filter, \hat{z} denotes the estimated value of the actual position of the unmanned helicopter in the z-axis direction of the inertial coordinate system, and \hat{v}_{z}=\dot{\hat{z}} denotes the actual velocity estimated value of the unmanned helicopter in the z-axis direction of the inertial coordinate system. \hat{D}_{z} denotes the estimated value of the lumped disturbance term in the z-axis direction of the inertial coordinate system. Q_{z}∈R^{2×2} denotes the covariance matrix of the estimated lumped disturbance term \hat{D}_{z}, in an embodiment,

$${Q}_{z} = [ \begin{matrix}0 & 0 \\ 0 & 5000\end{matrix} ] .$$

z_{z1}, z_{z2}, z_{z3} are the intermediate variables of the filter observer.

$${β}_{01}^{z} , {β}_{02}^{z} , {β}_{03}^{z}$$

are positive constants and their values satisfy

$${P}^{z} ( s ) = {s}^{3} + {β}_{01}^{z} {s}^{2} + {β}_{02}^{z} s + {β}_{03}^{z}$$

and belong to Hurwitz. In one embodiment,

$${β}_{01}^{z} = 18 , {β}_{02}^{z} = 108 , {β}_{03}^{z} = 216.$$

Step 3, a composite PID controller is designed for the position system model of the disturbed unmanned helicopter, the same three-channel composite PID controller is designed for the three axis directions of the inertial coordinate system:

$$\{ \begin{matrix}\frac{{T}_{m}}{m} ( cos ϕsinθcosψ + sin ϕsinψ ) = \\ - {K}_{p x} ( \hat{x} - {x}_{r} ) - {K}_{ix} \int ( \hat{x} - {x}_{r} ) - {K}_{d x} ( \hat{\dot{x}} - {\dot{x}}_{r} ) - {\hat{D}}_{x} \\ \frac{{T}_{m}}{m} ( cos ϕsinθsinψ - sin ϕcosψ ) = \\ - {K}_{py} ( \hat{y} - {y}_{r} ) - {K}_{iy} \int ( \hat{y} - {y}_{r} ) - {K}_{dy} ( \hat{\dot{y}} - {\dot{y}}_{r} ) - {\hat{D}}_{y} \\ \frac{{T}_{m}}{m} cos ϕcosθ + g = - {K}_{p z} ( \hat{z} - {z}_{r} ) - \\ {K}_{iz} \int ( \hat{z} - {z}_{r} ) - {K}_{dz} ( \hat{\dot{z}} - {z}_{r} ) - {\hat{D}}_{z}\end{matrix} \qquad ( 14 )$$

where (xᵣ, yᵣ, zᵣ) is the position reference indicated by the three-dimensional reference trajectory to be followed by the unmanned helicopter. (\hat{x}, ŷ, \hat{z}) is the actual position estimated value in the three axis directions of the inertial coordinate system, and (\hat{D}ₓ, \hat{D}_{y}, \hat{D}_{z}) is the estimated value of the lumped disturbance term in the three axis directions of the inertial coordinate system.

Kₚₓ, Kᵢₓ, K_{dx} are the proportional coefficient, integral coefficient, and differential coefficient in the x-axis direction of the inertial coordinate system. K_{py}, K_{iy}, K_{dy} are the proportional coefficient, integral coefficient and differential coefficient in the y-axis direction of the inertial coordinate system. K_{pz}, K_{iz}, K_{dz} are the proportional coefficient, integral coefficient and differential coefficient in the z-axis direction of the inertial coordinate system. Kₚⱼ, Kᵢⱼ, K_{dj} in any direction of j=x, y, z are positive constants and satisfy the polynomial P^{j}(s)=s³+K_{dj}s²+Kₚⱼs+Kᵢⱼ=0 and belong to Hurwitz. In one embodiment, Kₚₓ=12, K_{py}=K_{pz}=18.75, Kᵢₓ=8, K_{iy}=Kᵢₓ=15.625, K_{dx}=6, K_{dy}=K_{dz}=7.5.

Step 4, when the trajectory tracking control of the unmanned helicopter is performed, the current control variable of the unmanned helicopter and the position measurement value (xₘ, yₘ, zₘ) of the position measurement sensor are input into the filter observer to obtain the actual position estimated value (\hat{x}, ŷ, \hat{z}) and the lumped disturbance term estimated value (\hat{D}ₓ, \hat{D}_{y}, \hat{D}_{z}).

Then, the position error between the actual position estimated value (\hat{x}, ŷ, \hat{z}) and the three-dimensional reference trajectory (xᵣ, yᵣ, zᵣ) and the estimated value of the lumped disturbance term (\hat{D}ₓ, \hat{D}_{y}, \hat{D}_{z}) are input into the composite PID controller (14), and the unmanned helicopter is controlled according to the command value of the control variable output by the composite PID controller.

In the actual flight process of the unmanned helicopter, in order to facilitate the system control, it is always hoped that the heading angle of the unmanned helicopter is kept to zero, since this application mainly involves position control, the command value ψ^{d} of the heading angle ψ can be set to 0, that is, the fixed ψ=0 is substituted into Formula (14), and then the command value

$${T}_{m}^{d}$$

of the main rotor lift force Tₘ, the command value ϕ^{d} of the roll angle ϕ, and the command value θ^{d} of the pitching angle θ 0 can be obtained by the negative solution:

$$\{ \begin{matrix}{T}_{m}^{d} = m \sqrt{{a}_{x}^{2} + {a}_{y}^{2} + {( {a}_{z} - g )}^{2}} \\ {θ}^{d} = arctan ( \frac{{a}_{x}}{{a}_{z} - g} ) \\ {ϕ}^{d} = arcsin ( m \frac{{a}_{y}}{{T}_{m}^{d}} )\end{matrix} \qquad ( 15 )$$

In order to illustrate the effect of the trajectory tracking control method for the unmanned helicopter applied in this invention, the model of the unmanned helicopter is built by the Simulink toolbox in the simulation software MATLAB R2020b for simulation verification. In the case of fully considering the system lumped disturbance and measurement noise, in addition to the parameter settings provided in the above embodiment, other parameters in the simulation scenario are set as follows:

In the simulation example, m=6 kg, g=9.8 m/s², k_{d}=0.09 are set and the initial state of the unmanned helicopter as:

$$\{ \begin{matrix}x ( 0 ) = 0 , y ( 0 ) = 0 , z ( 0 ) = 0 \\ {v}_{x} ( 0 ) = 0 , {v}_{y} ( 0 ) = 0 , {v}_{z} ( 0 ) = 0\end{matrix}$$

The position command of the three-dimensional reference trajectory to be followed by the unmanned helicopter at any time t is as follows:

$$\{ \begin{matrix}{x}_{r} ( t ) = cos ( 0.2 π t ) \\ {y}_{r} ( t ) = sin ( 0.2 π t ) \\ {z}_{r} ( t ) = t\end{matrix}$$

The lumped disturbance term is set to:

$$\{ \begin{matrix}{D}_{x} = {D}_{y} = 3 , {D}_{z} = 2 & 0 s < t < 20 s \\ {D}_{x} = - 3 , {D}_{y} = {D}_{z} = - 2 & 20 s < t < 50 s\end{matrix}$$

In order to make the simulation results closer to the real situation, in the control process, the value range of the virtual control variable and its change rate in each channel direction is limited as follows:

$$\{ \begin{matrix}- 30 \leq {a}_{x} \leq 30 , & - 50 \leq {\dot{a}}_{x} \leq 50 \\ - 30 \leq {a}_{y} \leq 30 , & - 50 \leq {\dot{a}}_{y} \leq 50 \\ - 30 \leq {a}_{z} \leq 30 , & - 50 \leq {\dot{a}}_{z} \leq 50\end{matrix}$$

In the same simulation scenario, the traditional method of composite PID controller combined with an extended state observer (denoted as PID+ESO) and the method of composite PID controller combined with a filter observer (denoted as PID+KFESO) are used to control the trajectory tracking of the unmanned helicopter, and then the two control methods are compared and verified.

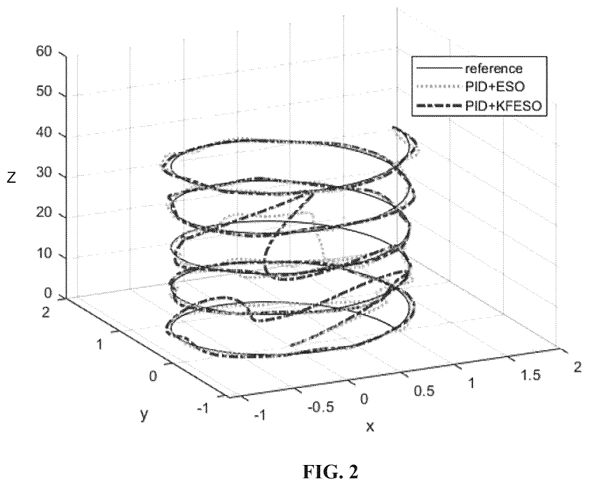

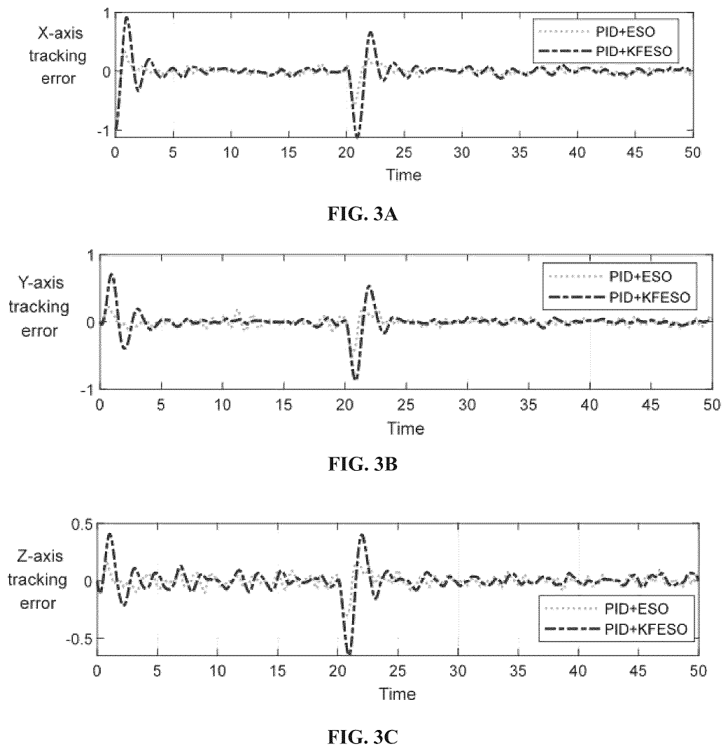

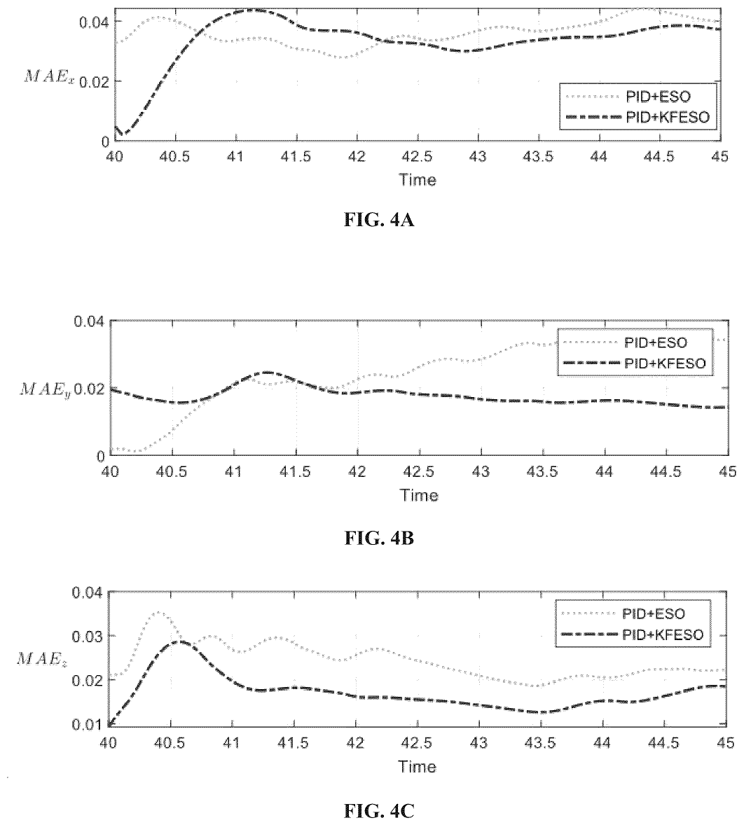

The three-dimensional space trajectory tracking response curve of the unmanned helicopter under the two control methods is shown in FIG. 2, and the three-channel tracking error response curve is shown in FIGS. 3A-3C. It can be seen from FIGS. 3A-3C, the steady-state tracking accuracy of the proposed PID+KFESO control method is higher than that of the traditional PID+ESO method. In order to show the steady-state tracking accuracy of the two control methods more intuitively, the mean absolute value of tracking error (MAE) is introduced to quantify the steady-state tracking accuracy. When the system reaches a steady state (t>30 s), the three-channel MAE response curve of trajectory tracking under the two control methods is shown in FIGS. 4A-4C, the statistical comparison results are as follows:

| | x -axis MAE(m) | y -axis MAE(m) | z -axis MAE(m) |
|---|---|---|---|
| PID + ESO | 0.0336 | 0.0346 | 0.0422 |
| PID + KFESO | 0.0397 | 0.0295 | 0.0373 |

It can be clearly seen from the above table data and FIGS. 4A-4C that the steady-state tracking accuracy of the proposed control method is better than that of the traditional PID+ESO method.

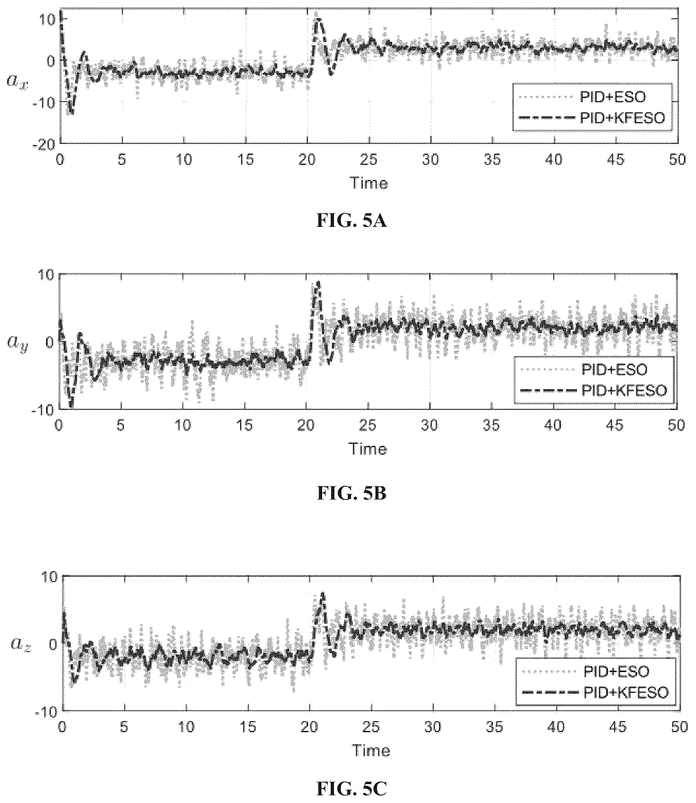

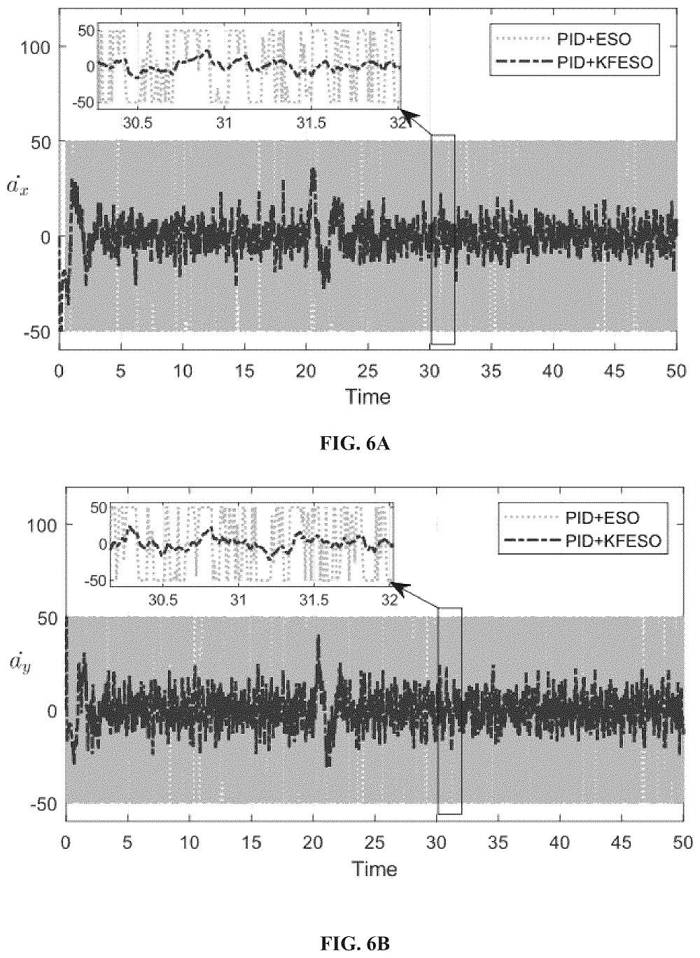

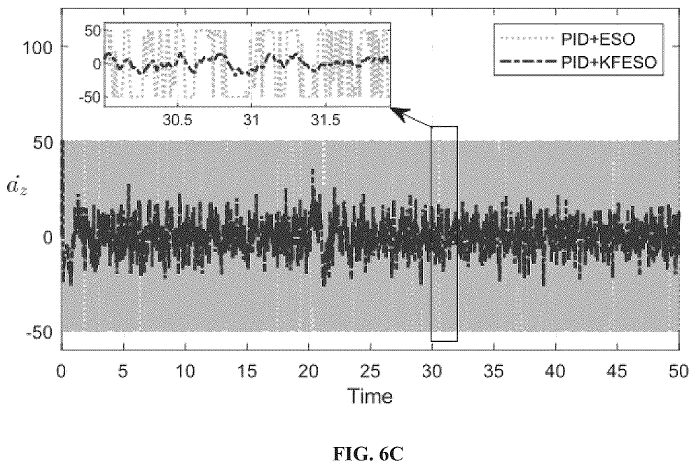

The response curves of the virtual control variable of the unmanned helicopter under the two control methods ARE shown in FIGS. 5A-5C. From FIGS. 5A-5C, it can be seen that the smoothness of the control variable of the PID+KFESO control method applied in this application is better than that of the traditional PID+ESO method, indicating that the method applied in this application can reduce the frequency of the reciprocating motion of the actuator, which is more in line with the engineering practice. In order to more intuitively show the control smoothness of the two control methods, the mean absolute value of acceleration change rate (MAR) is introduced to quantify the control smoothness. The three-channel MAR response curve of the control volume change rate under the two control methods is shown in FIGS. 6A-6C, the statistical comparison results are as follows:

| | x -axis MAR | y -axis MAR | z -axis MAR |
|---|---|---|---|
| PID + ESO | 43.5975 | 44.5635 | 45.4097 |
| PID + KFESO | 5.4346 | 6.6564 | 7.2974 |

It can be clearly seen from the above table data and FIGS. 6A-6C that the smoothness of the control variable of this application control method is better than that of the traditional PID+ESO method.

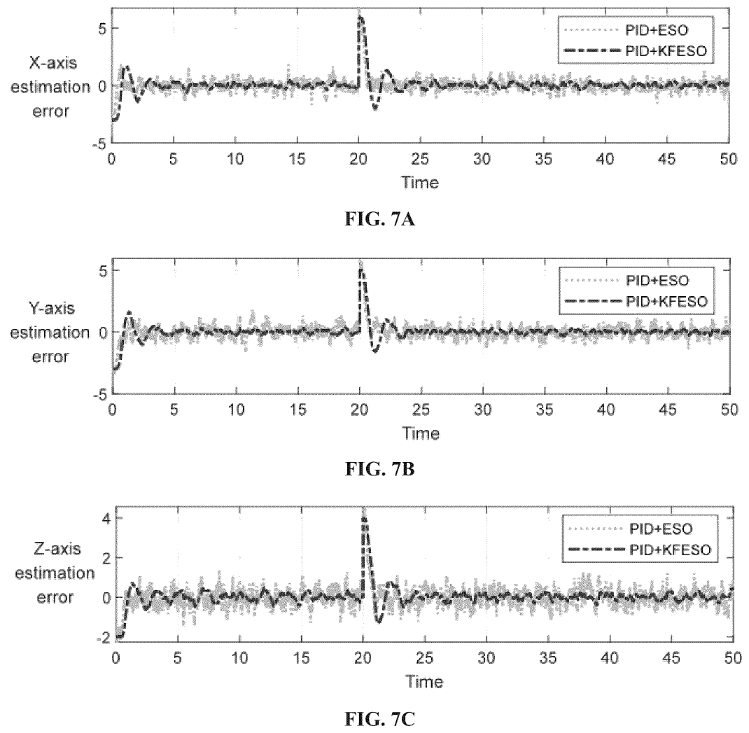

The estimation error response curves of the two control methods for the lumped disturbance term are shown in FIGS. 7A-7C. From the estimation error response curve of FIGS. 7A-7C, it can be seen that the proposed control method improves the estimation accuracy of the lumped disturbance term compared with the traditional PID+ESO method.

The above is only the preferred embodiment of this application, and this application is not limited to the above embodiment. Understandably, other improvements and changes directly derived or associated by technicians in this field without deviating from the spirit and conception of this application should be considered to be included in the scope of protection of this application.

What is claimed is:

1. A trajectory tracking control method for an unmanned helicopter based on a filter observer, wherein the trajectory tracking control method for the unmanned helicopter comprises:
establishing a position system model of a disturbed unmanned helicopter, the position system model of the disturbed unmanned helicopter comprises a position dynamic equation of the unmanned helicopter under an action of a control variable and a position measurement equation of a position measurement sensor in the unmanned helicopter, the position dynamic equation comprises a lumped disturbance term configured to characterize an external disturbance of the unmanned helicopter, the position measurement equation comprises a measurement noise term configured to characterize a measurement error disturbance of the position measurement sensor;
constructing a state vector by an actual position and an actual speed of the unmanned helicopter, transforming the position system model of the disturbed unmanned helicopter into a system state equation based on the state vector, and designing the filter observer based on a continuous-time Kalman filter according to the system state equation;
designing a composite proportion integration differentiation (PID) controller for the position system model of the disturbed unmanned helicopter;
when a trajectory tracking control of the unmanned helicopter is performed, inputting the control variable of the unmanned helicopter and a position measurement value of the position measurement sensor into the filter observer to obtain an actual position estimated value and an estimated value of the lumped disturbance term, inputting a position error between the actual position estimated value and a three-dimensional reference trajectory and the estimated value of the lumped disturbance term into the composite PID controller, and controlling the unmanned helicopter according to a command value of the control variable output by the composite PID controller;
the position dynamic equation of the unmanned helicopter is established as follows:
$$\{ \begin{matrix}\ddot{x} = - \frac{{k}_{d}}{m} \dot{x} + \frac{{T}_{m}}{m} ( cos ϕsinθcosψ + sin ϕsinψ ) + {D}_{x} \\ \ddot{y} = - \frac{{k}_{d}}{m} \dot{y} + \frac{{T}_{m}}{m} ( cos ϕsinθsinψ - sin ϕcosψ ) + {D}_{y} \\ \ddot{z} = - \frac{{k}_{d}}{m} \dot{z} + \frac{{T}_{m}}{m} cos ϕcosθ + g + {D}_{z}\end{matrix}$$
the position measurement equation of the position measurement sensor in the unmanned helicopter is established as follows:
$$\{ \begin{matrix}{x}_{m} = x + {v}_{mx} \\ {y}_{m} = y + {v}_{my} \\ {z}_{m} = z + {v}_{m z}\end{matrix}$$
wherein (x, y, z) is an actual position of the unmanned helicopter in three axis directions of an inertial coordinate system, (xₘ, yₘ, zₘ) is a position measurement value in the three axis directions of the inertial coordinate system obtained by the position measurement sensor in the unmanned helicopter, (vₘₓ, v_{my}, v_{mz}) is the measurement noise term of the position measurement sensor in the unmanned helicopter in the three axis directions of the inertial coordinate system; (Dₓ, D_{y}, D_{z}) is the lumped disturbance term in the three axis directions of the inertial coordinate system;
the control variables of the unmanned helicopter comprise a main rotor lift force Tₘ, roll angle ϕ, a pitching angle θ, and a heading angle ψ; m is a mass of the unmanned helicopter, g is an acceleration constant of gravity, k_{d} is a velocity damping coefficient;
the same three-channel composite PID controller is designed for the three axis directions of the inertial coordinate system:
$$\{ \begin{matrix}\frac{{T}_{m}}{m} ( cos ϕsinθcosψ + sin ϕsinψ ) = \\ - {K}_{p x} ( \hat{x} - {x}_{r} ) - {K}_{ix} \int ( \hat{x} - {x}_{r} ) - {K}_{d x} ( \hat{\dot{x}} - {\dot{x}}_{r} ) - {\hat{D}}_{x} \\ \frac{{T}_{m}}{m} ( cos ϕsinθsinψ - sin ϕcosψ ) = \\ - {K}_{py} ( \hat{y} - {y}_{r} ) - {K}_{iy} \int ( \hat{y} - {y}_{r} ) - {K}_{dy} ( \hat{\dot{y}} - {\dot{y}}_{r} ) - {\hat{D}}_{y} \\ \frac{{T}_{m}}{m} cos ϕcosθ + g = - {K}_{p z} ( \hat{z} - {z}_{r} ) - \\ {K}_{iz} \int ( \hat{z} - {z}_{r} ) - {K}_{dz} ( \hat{\dot{z}} - {z}_{r} ) - {\hat{D}}_{z}\end{matrix}$$
wherein (xᵣ, yᵣ, zᵣ) is a position reference indicated by the three-dimensional reference trajectory to be followed by the unmanned helicopter; (\hat{x}, ŷ, \hat{z}) is an actual position estimated value in the three axis directions of the inertial coordinate system, and (\hat{D}ₓ, \hat{D}_{y}, \hat{D}_{z}) is an estimated value of the lumped disturbance term in the three axis directions of the inertial coordinate system; Kₚₓ, Kᵢₓ, K_{dx} are proportional coefficient, integral coefficient and differential coefficient in an x-axis direction of the inertial coordinate system, K_{py}, K_{iy}, K_{dy} are proportional coefficient, integral coefficient and differential coefficient in a y-axis direction of the inertial coordinate system; K_{pz}, K_{iz}, K_{dz} are proportional coefficient, integral coefficient and differential coefficient in a z-axis direction of the inertial coordinate system; Kₚⱼ, Kᵢⱼ, K_{dj} in any direction of j=x, y, z are positive constants and satisfy a polynomial P^{j}(s)=s³+K_{dj}s²+Kₚⱼs+Kᵢⱼ=0 and belong to Hurwitz, s is a complex frequency domain parameter.

2. The trajectory tracking control method for the unmanned helicopter based on the filter observer according to claim 1, wherein the step of designing the filter observer comprises:
constructing a state vector X=[x vₓ]^{T} and a derivative \dot{X}=[\dot{x} \dot{v}ₓ]^{T} of the state vector of the unmanned helicopter in the x-axis direction of the inertial coordinate system, according to the position system model of the disturbed unmanned helicopter, the system state equation in the x-axis direction of the inertial coordinate system is
$$\{ \begin{matrix}\dot{X} = {A}_{x} X + {B}_{x} {a}_{x} + {B}_{d x} {D}_{x} \\ {x}_{m} = {H}_{x} X + {v}_{mx}\end{matrix} ,$$
and designing a filter observer in the x-axis direction of the inertial coordinate system to observe the actual position estimated value and the estimated value of the lumped disturbance term in the x-axis direction, wherein
$${A}_{x} = [ \begin{matrix}0 & 1 \\ 0 & - \frac{{k}_{d}}{m}\end{matrix} ] , {B}_{x} = [ \begin{matrix}0 \\ 1\end{matrix} ] , {B}_{dx} = [ \begin{matrix}0 \\ 1\end{matrix} ] , {H}_{x} = [ \begin{matrix}1 \\ 0\end{matrix} ] ,$$
a virtual control variable
$${a}_{x} = \frac{{T}_{m}}{m} ( cos ϕsinθcosψ + sin ϕsinψ ) ,$$
vₓ=\dot{x} denotes an actual speed of the unmanned helicopter in the x-axis direction of the inertial coordinate system;
constructing a state vector Y=[y v_{y}]^{T} and a derivative \dot{Y}=[\dot{y} \dot{v}_{y}]^{T} of the state T vector of the unmanned helicopter in the y-axis direction of the inertial coordinate system, according to the position system model of the disturbed unmanned helicopter, the system state equation in the y-axis direction of the inertial coordinate system is
$$\{ \begin{matrix}\dot{Y} = {A}_{y} Y + {B}_{y} {a}_{y} + {B}_{dy} {D}_{y} \\ {y}_{m} = {H}_{y} y + {v}_{my}\end{matrix} ,$$
and designing a filter observer in the y-axis direction of the inertial coordinate system to observe the actual position estimated value and the estimated value of the lumped disturbance term in the y-axis direction, wherein
$${A}_{y} = [ \begin{matrix}0 & 1 \\ 0 & - \frac{{k}_{d}}{m}\end{matrix} ] , {B}_{y} = [ \begin{matrix}0 \\ 1\end{matrix} ] , {B}_{dy} = [ \begin{matrix}0 \\ 1\end{matrix} ] , {H}_{y} = [ \begin{matrix}1 \\ 0\end{matrix} ] ,$$
a virtual control variable
$${a}_{y} = \frac{{T}_{m}}{m} ( cos ϕsinθsinψ - sin ϕcosψ ) ,$$
v_{y}=\dot{y} denotes an actual speed of the unmanned helicopter in the y-axis direction of the inertial coordinate system;
constructing a state vector Z=[z v_{z}]^{T} and a derivative Ż=[ż \dot{v}_{z}]^{T} of the state vector of the unmanned helicopter in the z-axis direction of the inertial coordinate system, according to the position system model of the disturbed unmanned helicopter, the system state equation in the x-axis direction of the inertial coordinate system is
$$\{ \begin{matrix}\dot{Z} = {A}_{z} Z + {B}_{z} {a}_{z} + {B}_{dz} {D}_{z} \\ {z}_{m} = {H}_{z} Z + {v}_{mz}\end{matrix} ,$$
and designing a filter observer in the z-axis direction of the inertial coordinate system to observe the actual position estimated value and the estimated value of the lumped disturbance term in the z-axis direction, wherein
$${A}_{z} = [ \begin{matrix}0 & 1 \\ 0 & - \frac{{k}_{d}}{m}\end{matrix} ] , {B}_{z} = [ \begin{matrix}0 \\ 1\end{matrix} ] , {B}_{dz} = [ \begin{matrix}0 \\ 1\end{matrix} ] , {H}_{z} = [ \begin{matrix}1 \\ 0\end{matrix} ] ,$$
a virtual control variable
$${a}_{z} = \frac{{T}_{m}}{m} cos ϕ cos θ + g ,$$
v_{z}=ż denotes an actual speed of the unmanned helicopter in the z-axis direction of the inertial coordinate system.

3. The trajectory tracking control method for the unmanned helicopter based on the filter observer according to claim 2, wherein the filter observer in the x-axis direction of the inertial coordinate system is designed as:
$$\begin{matrix}\{ \begin{matrix}{K}_{x} = {P}_{x} {H}_{x}^{T} {R}_{x}^{- 1} \\ \dot{\tilde{X}} = {A}_{x} \tilde{X} + {B}_{x} {a}_{x} + {B}_{dx} {\hat{D}}_{x} + {K}_{x} ( {x}_{m} - {H}_{x} \tilde{X} ) \\ {\dot{P}}_{x} = - {P}_{x} {H}_{x}^{T} {R}_{x}^{- 1} {H}_{x} {P}_{x} + {A}_{x} {P}_{x} + {P}_{x} {A}_{x}^{T} + {Q}_{x}\end{matrix} \\ \{ \begin{matrix}{e}_{Ox} = {z}_{x 1} - \tilde{x} \\ {\dot{z}}_{x 1} = {z}_{x 2} - {β}_{01}^{x} {e}_{Ox} \\ {\dot{z}}_{x 2} = {z}_{x 3} - {β}_{02}^{x} {e}_{Ox} - \frac{{k}_{d}}{m} {z}_{x 2} + {a}_{x} \\ {\dot{z}}_{x 3} = - {β}_{03}^{x} {e}_{Ox} \\ \hat{x} = {z}_{x 1} \\ \hat{\dot{x}} = {z}_{x 2} \\ {\hat{D}}_{x} = {z}_{x 3}\end{matrix}\end{matrix}$$
wherein Kₓ∈R^{2×1} is a Kalman gain, Pₓ∈R^{2×2} is a covariance matrix of a state vector estimation X, \tilde{X}=[\tilde{x} \tilde{v}ₓ]^{T} is an estimated value of a system state in the x-axis direction obtained by the Kalman filter, \tilde{\dot{X}}=[\tilde{\dot{x}} \tilde{\dot{v}}ₓ]^{T} is a first derivative of the estimated value \tilde{X}, \tilde{x} denotes a position estimated value in the x-axis direction obtained by the Kalman filter, and, \tilde{v}ₓ denotes a velocity estimated value in the x-axis direction obtained by the Kalman filter;
\hat{x} denotes an estimated value of the actual position of the unmanned helicopter in the x-axis direction of the inertial coordinate system, and \hat{v}ₓ=\dot{\hat{x}} denotes an actual velocity estimated value of the unmanned helicopter in the x-axis direction of the inertial coordinate system, \hat{D}ₓ denotes the estimated value of the lumped disturbance term in the x-axis direction of the inertial coordinate system; Qₓ∈R^{2×2} denotes a covariance matrix of an estimated lumped disturbance term \hat{D}ₓ; zₓ₁, zₓ₂, zₓ₃ are area intermediate variables of the filter observer,
$${β}_{01}^{x} , {β}_{02}^{x} , {β}_{03}^{x}$$
are positive constants and values of the positive constants satisfy
$${P}^{x} ( s ) = {s}^{3} + {β}_{01}^{x} {s}^{2} + {β}_{02}^{x} s + {β}_{03}^{x}$$
parameter, the measurement noise term vₘₓ is Gaussian white noise, Rₓ is a covariance of the measurement noise term vₘₓ.

4. The trajectory tracking control method for the unmanned helicopter based on the filter observer according to claim 2, wherein the filter observer in the y-axis direction of the inertial coordinate system is designed as:
$$\begin{matrix}\{ \begin{matrix}{K}_{y} = {P}_{y} {H}_{y}^{T} {R}_{y}^{- 1} \\ \dot{\tilde{Y}} = {A}_{y} \tilde{Y} + {B}_{y} {a}_{y} + {B}_{dy} {\hat{D}}_{y} + {K}_{y} ( {y}_{m} - {H}_{y} \tilde{Y} ) \\ {\dot{P}}_{y} = - {P}_{y} {H}_{y}^{T} {R}_{y}^{- 1} {H}_{y} {P}_{y} + {A}_{y} {P}_{y} + {P}_{y} {A}_{y}^{T} + {Q}_{y}\end{matrix} \\ \{ \begin{matrix}{e}_{Oy} = {z}_{y 1} - \tilde{y} \\ {\dot{z}}_{y 1} = {z}_{y 2} - {β}_{01}^{y} {e}_{Oy} \\ {\dot{z}}_{y 2} = {z}_{y 3} - {β}_{02}^{y} {e}_{Oy} - \frac{{k}_{d}}{m} {z}_{y 2} + {a}_{y} \\ {\dot{z}}_{y 3} = - {β}_{03}^{y} {e}_{Oy} \\ \hat{y} = {z}_{y 1} \\ \hat{\dot{y}} = {z}_{y 2} \\ {\hat{D}}_{y} = {z}_{y 3}\end{matrix}\end{matrix}$$
wherein K_{y}∈R^{2×1} is a Kalman gain, P_{y}∈R^{2×2} is a covariance matrix of a state vector estimation Y, \tilde{Y}=[\tilde{y} \tilde{v}_{y}]^{T} is an estimated value of a system state in the y-axis direction obtained by the Kalman filter, \tilde{\dot{Y}}=[\tilde{\dot{y}} \tilde{\dot{y}}_{y}]^{T} is a first derivative of the estimated value \tilde{Y}, \tilde{y} denotes a position estimated value in the y-axis direction obtained by the Kalman filter, and \tilde{v}_{y} denotes a velocity estimated value in the y-axis direction obtained by the Kalman filter;
ŷ denotes an estimated value of the actual position of the unmanned helicopter in the y-axis direction of the inertial coordinate system, and \hat{v}_{y}=\dot{ŷ} denotes the actual velocity estimated value of the unmanned helicopter in the y-axis direction of the inertial coordinate system, \hat{D}_{y} denotes the estimated value of the lumped disturbance term in the y-axis direction y of the inertial coordinate system; Q_{y}∈R^{2×2} denotes a covariance matrix of the estimated lumped disturbance term \hat{D}_{y}; z_{y1}, z_{y2}, z_{y3} are area intermediate variables of the filter observer;
$${β}_{01}^{y} , {β}_{02}^{y} , {β}_{03}^{y}$$
are positive constants and values of the positive constants satisfy
$${P}^{y} ( s ) = {s}^{3} + {β}_{01}^{y} {s}^{2} + {β}_{02}^{y} s + {β}_{03}^{y}$$
and belong to Hurwitz, s is the complex frequency domain parameter, the measurement noise term v_{my} is Gaussian white noise, R_{y} is a covariance of the measurement noise term Vₘₓ.

5. The trajectory tracking control method for the unmanned helicopter based on the filter observer according to claim 2, wherein the filter observer in the z-axis direction of the inertial coordinate system is designed as:
$$\begin{matrix}\{ \begin{matrix}{K}_{z} = {P}_{z} {H}_{z}^{T} {R}_{z}^{- 1} \\ \dot{\tilde{Z}} = {A}_{z} \tilde{Z} + {B}_{z} {a}_{z} + {B}_{dz} {\hat{D}}_{z} + {K}_{z} ( {z}_{m} - {H}_{z} \tilde{Z} ) \\ {\dot{P}}_{z} = - {P}_{z} {H}_{z}^{T} {R}_{z}^{- 1} {H}_{z} {P}_{z} + {A}_{z} {P}_{z} + {P}_{z} {A}_{z}^{T} + {Q}_{z}\end{matrix} \\ \{ \begin{matrix}{e}_{Oz} = {z}_{z 1} - \tilde{z} \\ {\dot{z}}_{z 1} = {z}_{z 2} - {β}_{01}^{z} {e}_{Oz} \\ {\dot{z}}_{z 2} = {z}_{z 3} - {β}_{02}^{z} {e}_{Oz} - \frac{{k}_{d}}{m} {z}_{z 2} + {a}_{z} \\ {\dot{z}}_{z 3} = - {β}_{03}^{z} {e}_{Oz} \\ \hat{z} = {z}_{z 1} \\ \hat{\dot{z}} = {z}_{z 2} \\ {\hat{D}}_{z} = {z}_{z 3}\end{matrix}\end{matrix}$$
wherein K_{z}∈R^{2×1} is a Kalman gain, P_{z}∈R^{2×2} is a covariance matrix of a state vector estimation Z, \tilde{Z}=[\tilde{z} \tilde{v}_{z}]^{T} is an estimated value of a system state in the z-axis direction obtained by the Kalman filter, \tilde{Ż}=[\tilde{ż} \tilde{\dot{v}}_{z}]^{T} is a first derivative of the estimated value \tilde{Z}, \tilde{z} denotes a position estimated value in the z-axis direction obtained by the Kalman filter, and \tilde{v}_{z}, denotes a velocity estimated value in the z-axis direction obtained by the Kalman filter;
\hat{z} denotes an estimated value of the actual position of the unmanned helicopter in the z-axis direction of the inertial coordinate system, and, \hat{v}_{z}=\dot{\hat{z}} denotes the actual velocity estimated value of the unmanned helicopter in the z-axis direction of the inertial coordinate system, \hat{D}_{z} denotes the estimated value of the lumped disturbance term in the z-axis direction of the inertial coordinate system; Q_{z}∈R^{2×2} denotes a covariance matrix of the estimated lumped disturbance term \hat{D}_{z}, z_{z1}, z_{z2}, z_{z3} are area intermediate variables of the filter observer;
$${β}_{01}^{z} , {β}_{02}^{z} , {β}_{03}^{z}$$
are positive constants and values of the positive constants satisfy
$${P}^{z} ( s ) = {s}^{3} + {β}_{01}^{z} {s}^{2} + {β}_{02}^{z} s + {β}_{03}^{z}$$
parameter, the measurement noise term v_{mz} is Gaussian white noise, R_{z} is a covariance of the measurement noise term v_{mz}.

6. The trajectory tracking control method for the unmanned helicopter based on the filter observer according to claim 1, wherein the step of obtaining the command value of the control variable of the unmanned helicopter comprises:
on a basis of keeping the command value of the heading angle ψ^{d}=0, obtaining a command value of the main rotor lift force
$${T}_{m}^{d} ,$$
a command value of the roll angle ϕ^{d} and a command value of the pitching angle θ^{d} by using a designed filter observer combined with the composite PID controller:
$$\{ \begin{matrix}{T}_{m}^{d} = m \sqrt{{a}_{x}^{2} + {a}_{y}^{2} + {( {a}_{z} - g )}^{2}} \\ {θ}^{d} = arctan ( \frac{{a}_{x}}{{a}_{z} - g} ) \\ {ϕ}^{d} = arcsin ( m \frac{{a}_{y}}{{T}_{m}^{d}} )\end{matrix} \\ wherein \{ \begin{matrix}{a}_{x} = \frac{{T}_{m}}{m} ( cos ϕ sin θ cos ψ + sin ϕ sin ψ ) \\ {a}_{y} = \frac{{T}_{m}}{m} ( cos ϕ sin θ sin ψ - sin ϕ cos ψ ) \\ {a}_{z} = \frac{{T}_{m}}{m} cos ϕ cos θ + g\end{matrix}$$
